(19) United States
(12) Patent Application Publication
(10) Pub. No.: US 2022/0374907 A1
(43) Pub. Date: Nov. 24, 2022

(54) IC CARD INCLUDING REGISTERED BIOMETRIC INFORMATION AND REGISTERED PIN INFORMATION, OPERATION METHOD THEREOF, AND OPERATION METHOD OF CARD READER COMMUNICATING WITH IC CARD

(71) Applicant: SAMSUNG ELECTRONICS CO., LTD., Suwon-si (KR)

(72) Inventor: JEEHYOUNG LEE, Suwon-si (KR)

(21) Appl. No.: 17/533,924

(22) Filed: Nov. 23, 2021

(30) Foreign Application Priority Data
May 18, 2021 (KR) 10-2021-0063870

(51) Int. Cl. G06Q 20/40; G06K 7/00

(52) U.S. Cl. CPC G06Q 20/40145; G06Q 20/409; G06Q 20/4012; G06K 7/0069; G06Q 20/407

(57) ABSTRACT

Disclosed is a method of operating an integrated circuit (IC) card that is configured to communicate with a card reader and includes registered biometric information and registered PIN information. The method includes determining whether biometric information received from a user and the registered biometric information on the IC card match, in response to determining that the biometric information and the registered biometric information do not match, outputting to the card reader, a first response indicating a biometric verification fail, determining whether PIN information received from the card reader and the registered PIN information on the IC card match responsive to receiving a PIN verification request from the card reader that was based on the first response indicating the biometric verification fail, and outputting to the card reader a second response indicating whether the PIN information and the registered PIN information match.

### CROSS-REFERENCE TO RELATED APPLICATIONS

This application claims priority under 35 U.S.C. § 119 to Korean Patent Application No. 10-2021-0063870 filed on May 18, 2021, in the Korean Intellectual Property Office, the disclosures of which are incorporated by reference herein in their entireties.

### BACKGROUND

Embodiments of the present disclosure described herein relate to an integrated circuit (IC) card, and more particularly, relate to an IC card including registered biometric information and registered PIN information, an operation method of the IC card, and an operation method of the card reader communicating with the IC card.

An integrated circuit (IC) card that has a semiconductor-based IC chip embedded within may store a huge amount of data and may provide high security, and thus, the IC card is being utilized in various fields such as communication, finance, transportation, and e-commerce. The IC card may be classified as a contact card that communicates with a card reader through a physical contact and a contactless card that communicates with the card reader through a wireless signal.

In an IC card in which a biometric sensor is embedded, payment is made when biometric verification using biometric information of a card user is successful. When the trial number of the biometric verification exceeds the given trial number, the biometric verification is not performed any longer, and the payment of the IC card is not performed. To again make a payment by using the IC card, there is the inconvenience of visiting the bank issuing the IC card and re-registering biometric information. Accordingly, an IC card and an operation method of the IC card may be needed such that they are capable of making a payment through other verification schemes beyond the biometric verification scheme, when the trial number of the biometric verification exceeds the trial number defined in advance.

### SUMMARY

Embodiments of the present disclosure provide an IC card including registered biometric information and registered PIN information, a method of operating the IC card, and a method of operating the card reader that is configured to communicate with the IC card.

According to some embodiments, a method of operating an integrated circuit (IC) card that is configured to communicate with a card reader and includes registered biometric information and registered PIN information includes determining whether biometric information received from a user and the registered biometric information on the IC card match, in response to determining that the biometric information and the registered biometric information do not match, outputting to the card reader a first response indicating a biometric verification fail, determining whether PIN information received from the card reader and the registered PIN information on the IC card match responsive to receiving a PIN verification request from the card reader that was based on the first response indicating the biometric verification fail, and outputting to the card reader, a second response indicating whether the PIN information and the registered PIN information match.

According to some embodiments, an integrated circuit (IC) card includes a biometric sensor that is configured to generate biometric information, and a control circuit that stores registered biometric information and registered PIN information and is configured to communicate with the biometric sensor and a card reader that is external to the IC card. The control circuit receives a biometric verification request from the card reader, determines whether the biometric information and the registered biometric information match, based on the biometric verification request, outputs a first response indicating a biometric verification fail to the card reader, in response to determining that the biometric information and the registered biometric information do not match, receives a PIN verification request and PIN information from the card reader responsive to the first response indicating the biometric verification fail, determines whether the PIN information and the registered PIN information match, based on the PIN verification request, and outputs a second response indicating whether the PIN information and the registered PIN information match, to the card reader.

According to some embodiments, a method of operating a card reader that is configured to communicate with an integrated circuit (IC) card that stores registered biometric information and registered PIN information includes outputting a biometric verification request to the IC card, receiving, from the IC card, a first response indicating a biometric verification fail of the biometric verification request for the registered biometric information, outputting a PIN verification request and PIN information to the IC card, based on the first response indicating the biometric verification fail, and receiving, from the IC card, a second response indicating whether the PIN information and the registered PIN information match.

### BRIEF DESCRIPTION OF THE FIGURES

The above and other objects and features of the present disclosure will become apparent by describing in detail embodiments thereof with reference to the accompanying drawings.

FIG. 1 is a block diagram of an IC card system according to some embodiments of the present disclosure.

FIG. 2 is a block diagram illustrating an IC card of FIG. 1 in detail, according to some embodiments of the present disclosure.

FIG. 3A is a block diagram illustrating an operation method of an IC card of FIG. 2 in detail, according to some embodiments of the present disclosure.

FIG. 3B is a block diagram illustrating an operation method of an IC card of FIG. 2 in detail, according to some embodiments of the present disclosure.

FIG. 3C is a block diagram illustrating an operation method of an IC card of FIG. 2 in detail, according to some embodiments of the present disclosure.

FIG. 4 is a diagram illustrating an IC card of FIG. 2, according to some embodiments of the present disclosure.

FIG. 5 is a flowchart illustrating an operation method of an IC card system according to some embodiments of the present disclosure.

FIG. 6 is a diagram illustrating a card reader of FIG. 1, according to some embodiments of the present disclosure.

FIG. 7 is a flowchart illustrating an operation method of an IC card according to some embodiments of the present disclosure.

FIG. 8 is a flowchart illustrating an operation method of a card reader according to some embodiments of the present disclosure.

### DETAILED DESCRIPTION

Below, embodiments of the present disclosure will be described in detail and clearly to such an extent that one skilled in the art may easily carry out the present disclosure. With regard to the description of the present disclosure, to make the overall understanding easy, similar components will be marked by similar reference signs/numerals in drawings, and thus, additional description will be omitted to avoid redundancy.

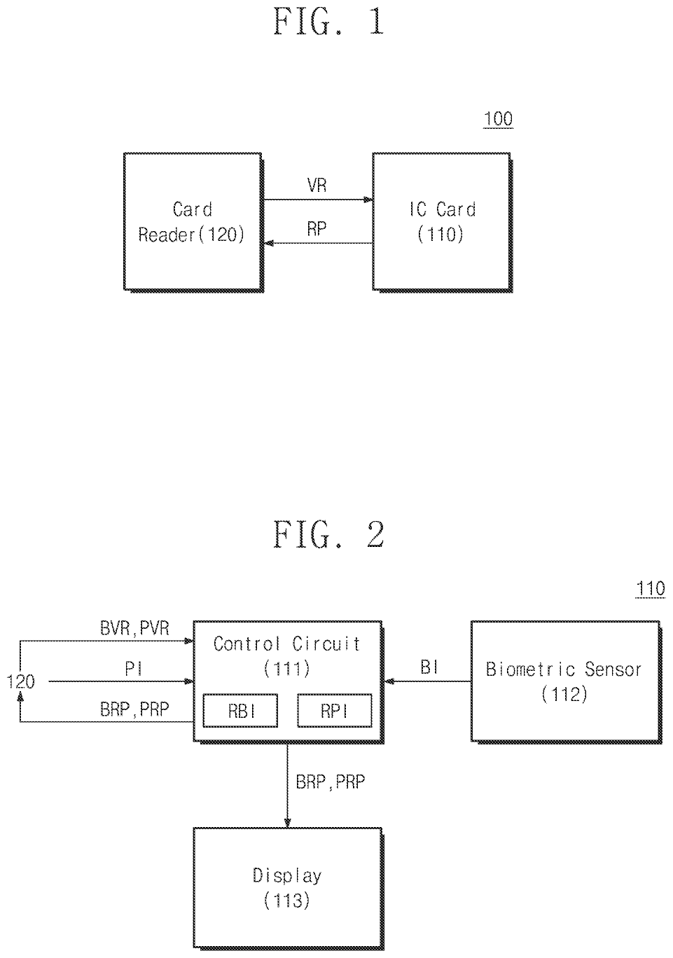

FIG. 1 is a block diagram illustrating an IC card system 100 according to some embodiments of the present disclosure. Referring to FIG. 1, the IC card system 100 may include an integrated circuit (IC) card 110 and a card reader 120. The IC card 110 and the card reader 120 may communicate with each other through a physical contact or wireless communication. While traditional credit cards may use magnetic tape to store information, an IC card may use a large capacity embedded IC chip to store information directly on the card. The IC chip may perform computer operations and/or mathematical calculations.

In some embodiments, the IC card system 100 may be a system configured to make a financial payment through the communication between the IC card 110 and the card reader 120. For example, the IC card 110 may be a card for financial payment, which includes identity information of a user. The card reader 120 may be a device that checks the identity information of a user of the IC card 110 and requests a financial payment. However, the present disclosure is not limited thereto. For example, the card reader 120 may be a building access system, an identity authentication system, or a book rental system.

The card reader 120 may output a verification request VR to the IC card 110. For example, the verification request VR may refer to a request for checking whether the user of the IC card 110 is an authenticated user. The authenticated user may refer to a user that has the authority to make a payment by using the IC card 110. The verification request VR may include a biometric verification request using biometric verification, a PIN verification request using a personal information number (PIN) verification, etc. In some embodiments, the IC card 110 may be a plastic card in which an integrated circuit is embodied in the form of a chip.

The IC card 110 may perform a verification operation according to the verification request VR. For example, the IC card 110 may determine whether a user according to the verification request VR is the authenticated user. The IC card 110 may generate a verification response RP, based on a result of the verification operation according to the verification request VR. The verification response RP may include a verification result corresponding to the verification request VR. The IC card 110 may output the verification response RP to the card reader 120.

The verification response RP may include a response indicating a verification success or a response indicating a verification fail. For example, when the IC card 110 determines that the user according to the verification request VR is the authenticated user, the IC card 110 may generate the verification response RP indicating a verification success. For example, when the IC card 110 determines that the user according to the verification request VR is not the authenticated user, the IC card 110 may generate the verification response RP indicating a verification fail.

The card reader 120 may receive the verification response RP from the IC card 110. The card reader 120 may perform a next (or follow-up) operation based on the verification response RP received from the IC card 110. For example, when the verification response RP indicates a verification fail, the card reader 120 may further output any other verification request to the IC card 110 or may terminate an operation. For example, when the verification response RP indicates a verification success, the card reader 120 may output a transaction request to the IC card 110.

FIG. 2 is a block diagram illustrating an IC card of FIG. 1 in detail, according to some embodiments of the present disclosure. Referring to FIG. 2, the IC card 110 may include a control circuit 111, a biometric sensor 112, and a display 113.

The control circuit 111 of IC card 110 may include registered biometric information RBI and registered PIN information RPI. For example, the registered biometric information RBI may be fingerprint information of the authenticated user. The registered PIN information RPI may be information about a series of numbers (or digits) determined in advance by the authenticated user. The registered PIN information RPI may be information including four numbers (or digits), but the present disclosure is not limited thereto. For example, the number of digits of the registered PIN information RPI may increase or decrease. The registered biometric information RBI and registered PIN information RPI may be stored in an active or a passive memory of the IC card. The registered PIN information RPI may be directly stored or may be scrambled or encrypted before storing on the IC card.

The control circuit 111 may verify whether a user of the IC card 110 is the authenticated user. In some embodiments, the control circuit 111 may verify whether the user is the authenticated user, based on a biometric verification operation and a PIN verification operation.

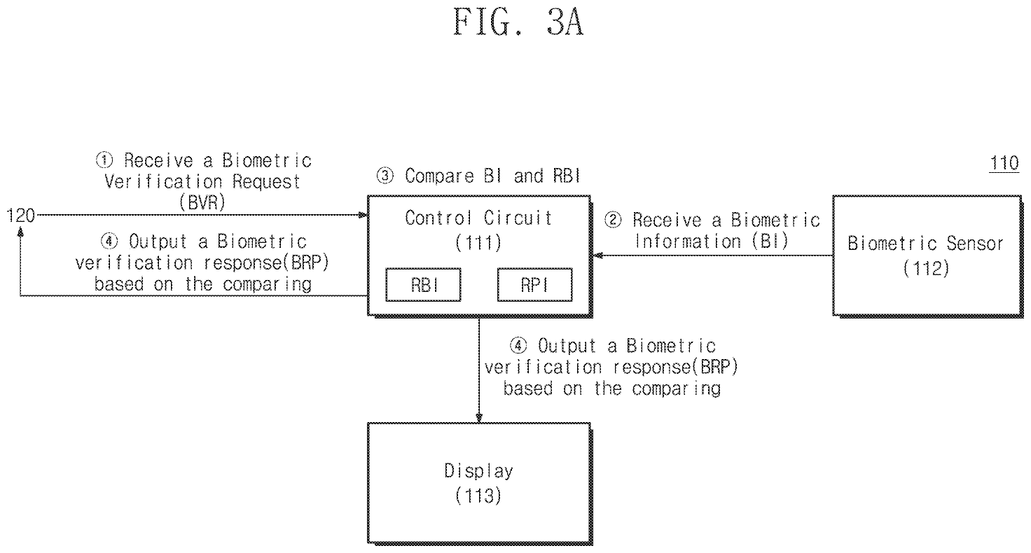

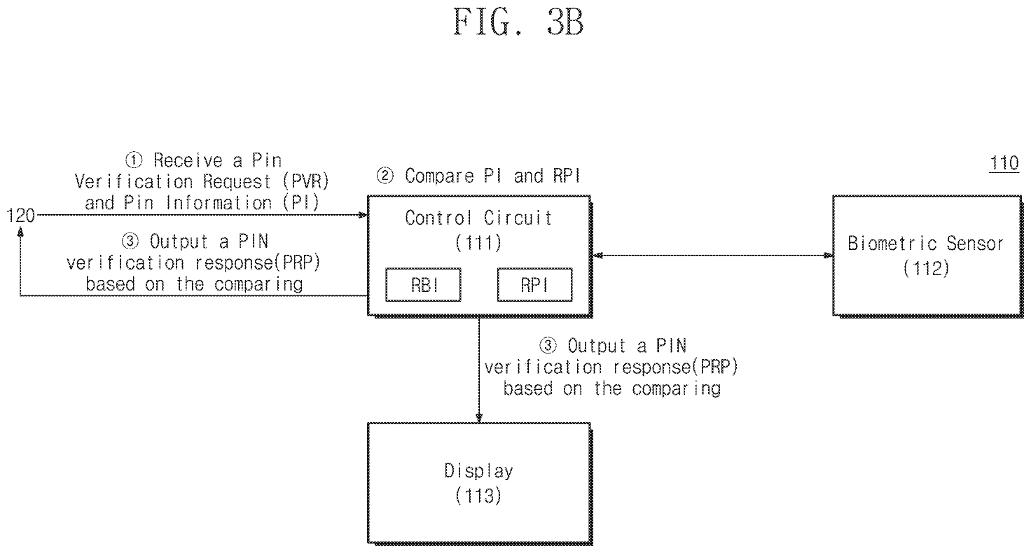

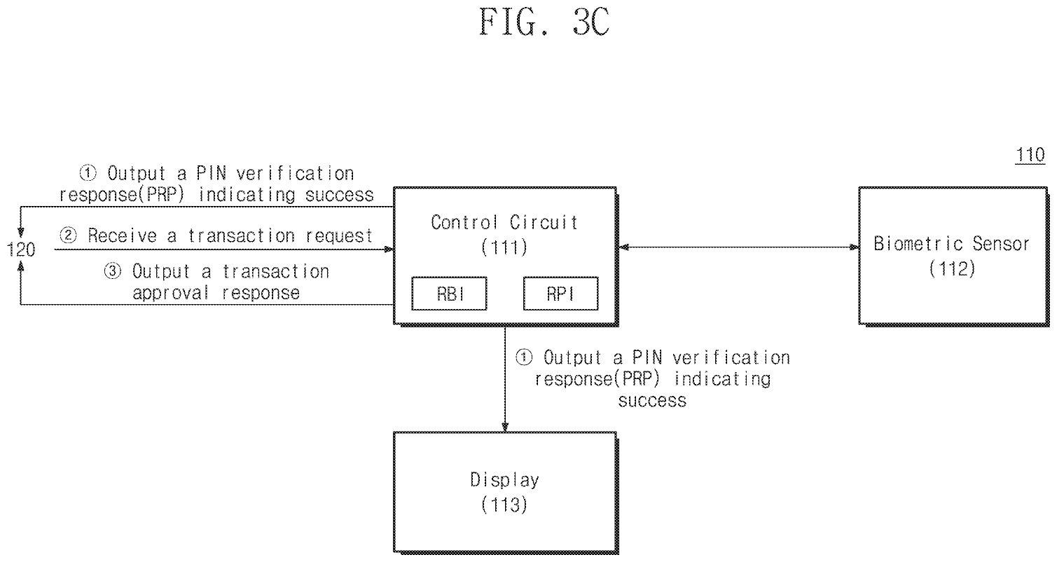

The biometric verification operation may refer to an operation of determining whether biometric information BI and the registered biometric information RBI match. The user's biometric data is stored on the IC card, not on a central database. This storage of biometric data on the IC card improves the security of user information in the event that a bank or other vendor has been subjected to a cyber attack. The biometric information BI is checked locally at the IC card, since the registered biometric information RBI is stored on the IC card. In other words, the registered biometric information RBI does not leave the IC card, thereby improving security of the user's information. The biometric verification operation will be described in more detail with reference to FIG. 3A.

The PIN verification operation may refer to an operation of determining whether PIN information PI and the registered PIN information RPI match. The PIN verification operation will be described in more detail with reference to FIGS. 3B and 3C.

The control circuit 111 may receive a biometric verification request BVR from the card reader 120. The biometric verification request BVR may refer to a request for checking whether the user of the IC card 110 is the authenticated user, based on the biometric information BI and the registered biometric information RBI. The biometric information BI may be fingerprint information of the user.

The control circuit 111 may determine whether the biometric information BI and the registered biometric information RBI match, based on the biometric verification request BVR. The control circuit 111 may output a biometric verification response BRP to the card reader 120, based on whether the biometric information BI and the registered biometric information RBI match. The biometric verification response BRP may include a response indicating a biometric verification success or a response indicating a biometric verification fail.

For example, when the biometric information BI and the registered biometric information RBI match, the control circuit 111 may output the biometric verification response BRP indicating the biometric verification success to the card reader 120. For example, when the biometric information BI and the registered biometric information RBI do not match, the control circuit 111 may output the biometric verification response BRP indicating the biometric verification fail to the card reader 120.

The control circuit 111 may receive a PIN verification request PVR and the PIN information PI from the card reader 120. The PIN verification request PVR may refer to a request for checking whether the user of the IC card 110 is the authenticated user, based on the PIN information PI and the registered PIN information RPI. The PIN information PI may include information about a series of numbers that are decided by the user and are received from the card reader 120.

The control circuit 111 may determine whether the PIN information PI and the registered PIN information RPI match, based on the PIN verification request PVR. The control circuit 111 may output a PIN verification response PRP to the card reader 120, based on whether the PIN information PI and the registered PIN information RPI match.

For example, when the PIN information PI and the registered PIN information RPI match, the control circuit 111 may output the PIN verification response PRP indicating a PIN verification success to the card reader 120. When the PIN information PI and the registered PIN information RPI do not match, the control circuit 111 may output the PIN verification response PRP indicating a PIN verification fail to the card reader 120.

The biometric sensor 112 may generate the biometric information BI. The biometric sensor 112 may output the biometric information BI to the control circuit 111. In some embodiments, the biometric sensor 112 may sense a fingerprint of the user of the IC card 110 and may generate the biometric information BI based on the sensed fingerprint. However, the present disclosure is not limited thereto. For example, the biometric sensor 112 may sense a variety of body information for seizing the identity of the user, such as a voice, a face, an iris, and a vein distribution, and may generate the biometric information BI based on one or more elements of the sensed body information.

The display 113 may output the biometric verification response BRP and the PIN verification response PRP to the user. For example, when the biometric information BI and the registered biometric information RBI do not match, the display 113 may output a “verification fail”. For example, when the PIN information PI and the registered PIN information RPI match, the display 113 may output a “verification success”.

FIG. 3A is a block diagram illustrating an operation method of an IC card of FIG. 2 in detail, according to some embodiments of the present disclosure. A biometric verification operation method of the IC card 110 will be described with reference to FIGS. 2 and 3A. The IC card 110 may communicate with the card reader 120. The IC card 110 may include the control circuit 111, the biometric sensor 112, and the display 113. The IC card 110 may perform the biometric verification operation based on the biometric information BI and the registered biometric information RBI. The control circuit 111 may receive the biometric verification request BVR from the card reader 120. The biometric verification request BVR may refer to a request for checking an identity of the user, based on the biometric information BI and the registered biometric information RBI.

The control circuit 111 may receive the biometric information BI from the biometric sensor 112. The biometric information BI may include biometric information (e.g., fingerprint information) of a current user of the IC card 110.

To determine whether the biometric information BI and the registered biometric information RBI match, the control circuit 111 may compare the biometric information BI and the registered biometric information RBI based on the biometric verification request BVR. The registered biometric information RBI may include biometric information of the authenticated user and may refer to information stored in the control circuit 111.

The control circuit 111 may output the biometric verification response BRP to the card reader 120 and the display 113, based on whether the biometric information BI and the registered biometric information RBI match. For example, when the biometric information BI and the registered biometric information RBI do not match, the biometric verification response BRP may indicate a verification fail. For example, when the biometric information BI and the registered biometric information RBI match, the biometric verification response BRP may indicate a verification success.

FIG. 3B is a block diagram illustrating an operation method of an IC card of FIG. 2 in detail, according to some embodiments of the present disclosure. A PIN verification operation method of the IC card 110 will be described with reference to FIGS. 2 and 3B. The IC card 110 may communicate with the card reader 120. The IC card 110 may include the control circuit 111, the biometric sensor 112, and the display 113. The IC card 110 may perform the PIN verification operation based on the PIN information PI and the registered PIN information RPI.

The control circuit 111 may receive the PIN verification request PVR and the PIN information PI from the card reader 120. The PIN verification request PVR may refer to a request for checking an identity of the user based on the PIN information PI and the registered PIN information RPI. The PIN information PI may include information about a series of numbers (or digits) that a current user inputs to the card reader 120.

To determine whether the PIN information PI and the registered PIN information RPI match, the control circuit 111 may compare the PIN information PI and the registered PIN information RPI based on the PIN verification request PVR. The registered PIN information RPI may include PIN information decided in advance by the authenticated user and may refer to information stored in the control circuit 111.

The control circuit 111 may output the PIN verification response PRP to the card reader 120 and the display 113, based on whether the PIN information PI and the registered PIN information RPI match. For example, when the PIN information PI and the registered PIN information RPI do not match, the PIN verification response PRP may indicate a verification fail. For example, when the PIN information PI and the registered PIN information RPI match, the PIN verification response PRP may indicate a verification success.

In some embodiments, the PIN verification operation described with reference to FIG. 3B may be a verification operation that is performed as a follow-up operation after a verification fail occurs in the biometric verification operation described with reference to FIG. 3A.

FIG. 3C is a block diagram illustrating an operation method of an IC card of FIG. 2 in detail, according to some embodiments of the present disclosure. An operation method of the IC card 110 that performs a transaction request will be described with reference to FIGS. 2 and 3C. The IC card 110 may communicate with the card reader 120. The IC card 110 may include the control circuit 111, the biometric sensor 112, and the display 113. When the PIN verification operation succeeds, the IC card 110 may process a transaction request.

The control circuit 111 may output the PIN verification response PRP indicating a PIN verification success to the card reader 120 and the display 113. For example, when the control circuit 111 determines that the PIN information PI and the registered PIN information RPI match, the control circuit 111 may output the PIN verification response PRP indicating a PIN verification success to the card reader 120 and the display 113.

After outputting the PIN verification response PRP indicating the PIN verification success to the card reader 120, the control circuit 111 may receive a transaction request from the card reader 120. The control circuit 111 may output a transaction approval response to the card reader 120 based on the transaction request. When the control circuit 111 outputs the transaction approval response to the card reader 120, the card reader 120 may communicate with an external server (not illustrated) such that a financial payment is made by the authenticated user of the IC card 110.

In some embodiments, unlike the example illustrated in FIG. 3C, after outputting the biometric verification response BRP indicating a biometric verification success to the card reader 120 and the display 113, the control circuit 111 may receive a transaction request from the card reader 120 and may output a transaction approval response to the card reader 120 (refer to FIGS. 3A and 3C).

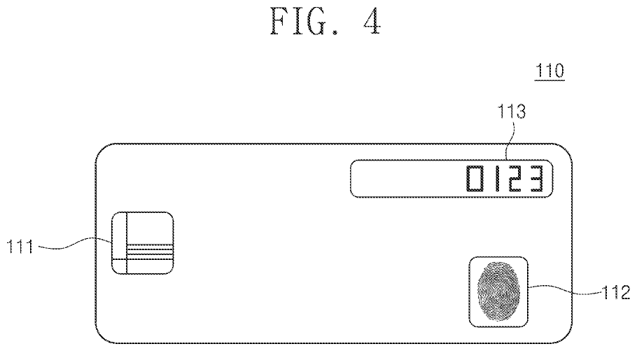

FIG. 4 is a diagram illustrating an IC card 110 of FIG. 2, according to some embodiments of the present disclosure. Referring to FIG. 4, the IC card 110 may include the control circuit 111, the biometric sensor 112, and the display 113. The control circuit 111, the biometric sensor 112, and the display 113 of FIG. 4 may respectively correspond to the control circuit 111, the biometric sensor 112, and the display 113 of FIG. 2.

The control circuit 111 may be implemented with an IC chip and may be attached on a surface of the IC card 110. For example, the IC chip may include a metal pattern attached on the surface of the IC card 110. In some embodiments, as the IC chip physically contacts a card reader, the IC card 110 may communicate with the card reader.

The biometric sensor 112 may be a sensor that senses a fingerprint of a user of the IC card 110. The biometric sensor 112 may sense the fingerprint of the user of the IC card 110 to generate biometric information. The biometric sensor 112 may output the biometric information to the control circuit 111.

The display 113 may output a result (i.e., a verification success or a verification fail) of the verification operation (e.g., a biometric verification operation or a PIN verification operation) of the IC card 110 to the user. The display 113 that outputs number information is illustrated for brevity of drawing, but the present disclosure is not limited thereto. For example, the display 113 may output a variety of information, which is associated with a verification operation, such as a name of the user of the IC card 110, a unique serial number, and/or an expiration date.

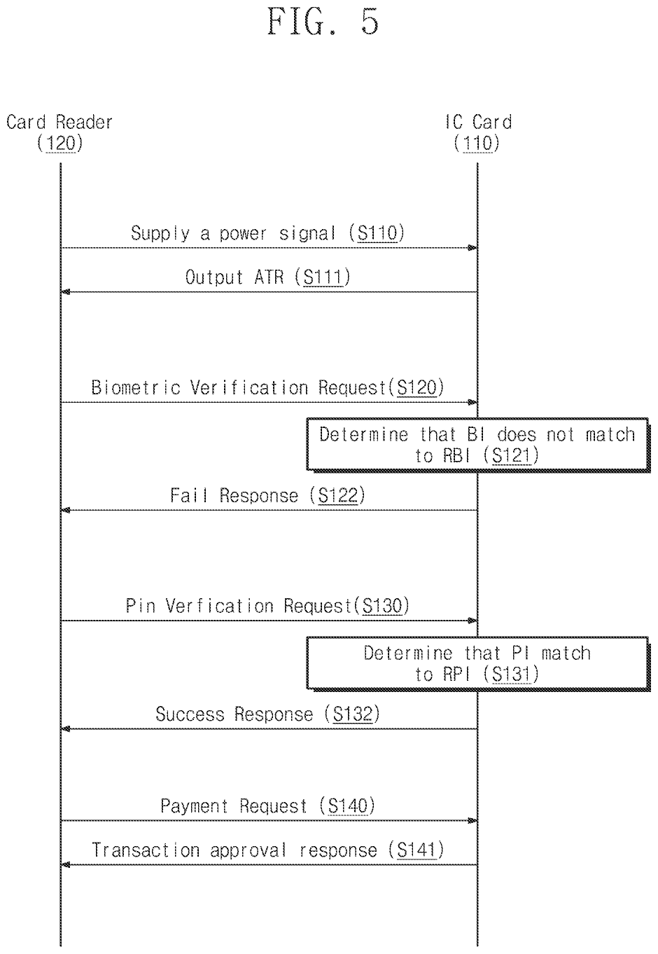

FIG. 5 is a flowchart illustrating an operation method of an IC card system according to some embodiments of the present disclosure. An operation method of an IC card system including the IC card 110 and the card reader 120 will be described with reference to FIG. 5. The IC card 110 may correspond to the IC card 110 of FIG. 2. The card reader 120 may correspond to the card reader 120 of FIG. 2.

In operation S110, the card reader 120 may supply a power signal to the IC card 110. The power signal may provide a power necessary for the IC card 110 to perform a verification operation and to process a transaction request. In some embodiments, when the IC card 110 physically contacts the card reader 120, the card reader 120 may supply power to the IC card 110.

In operation S111, the IC card 110 may output an answer to reset (ATR) signal to the card reader 120. The ATR signal may be a signal complying with the standard for communication of the IC card 110 and may include a message that is output after the IC card 110 is electrically reset.

For example, when the card reader 120 receives the ATR signal from the IC card 110, the card reader 120 may enter a state in which the communication with the IC card 110 is possible. When the card reader 120 fails to receive the ATR signal from the IC card 110, the card reader 120 may enter a state in which the communication with the IC card 110 is impossible. The card reader 120 may perform a next operation, such as a verification request, based on the ATR signal received from the IC card 110.

In operation S120, the card reader 120 may output a biometric verification request to the IC card 110. In operation S121, based on the biometric verification request, the IC card 110 may determine that the biometric information BI and the registered biometric information RBI do not match. When the IC card 110 determines that the biometric information BI and the registered biometric information RBI match, the IC card 110 may perform operation S132, unlike the example illustrated in FIG. 5.

In operation S122, based on determining that the biometric information BI and the registered biometric information RBI do not match, the IC card 110 may output a response indicating a biometric verification fail to the card reader 120.

In operation S130, the card reader 120 may output a PIN verification request to the IC card 110. In operation S131, based on the PIN verification request, the IC card 110 may determine that the PIN information PI and the registered PIN information RPI match. That the PIN information PI and the registered PIN information RPI match may mean that a user of the IC card 110 coincides with the authenticated user. When the IC card 110 determines that the PIN information PI and the registered PIN information RPI do not match, the IC card 110 may block a transaction function (or may prevent a transaction function from being enabled).

In operation S132, based on determining that the PIN information PI and the registered PIN information RPI match, the IC card 110 may output a response indicating a PIN verification success to the card reader 120.

In operation S140, the card reader 120 may output a transaction request to the IC card 110. For example, the transaction request may include information about payment such as an amount to be paid and a payment location.

In operation S141, the IC card 110 may output a transaction approval response to the card reader 120. When the card reader 120 receives the transaction approval response, the card reader 120 may communicate with an external server to process the payment by the authenticated user of the IC card 110.

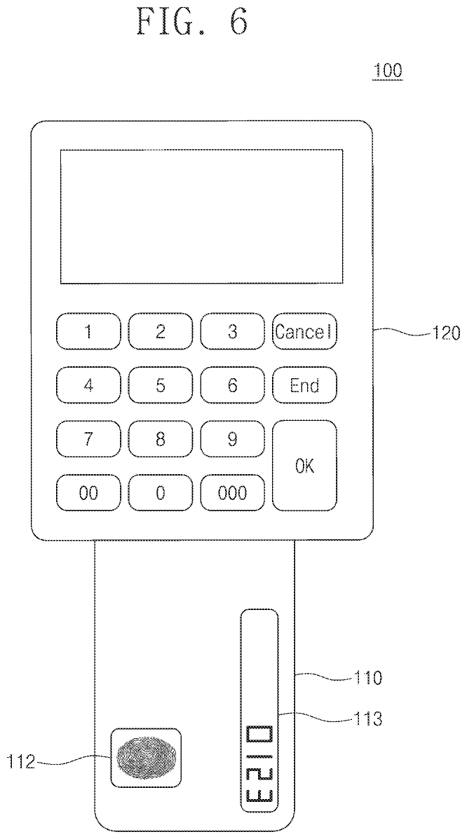

FIG. 6 is a diagram illustrating an IC card system of FIG. 1, according to some embodiments of the present disclosure. The IC card system 100 including the IC card 110 and the card reader 120 will be described with reference to FIG. 6. The IC card system 100 may correspond to the IC card system of FIG. 5. The IC card 110 may correspond to the IC card 110 of FIG. 4.

The IC card 110 and the card reader 120 may communicate with each other through a physical contact or wireless communication. In some embodiments, as the IC chip of the IC card 110 is inserted into the card reader 120, the IC card 110 may communicate with the card reader 120. In some embodiments, the IC card 110 may communicate with the card reader 120 by outputting a wireless frequency signal to the card reader 120 and receiving a wireless frequency signal from the card reader 120.

In some embodiments, the card reader 120 may include an insertion hole into which the IC card 110 is capable of being inserted for communication with the IC card 110. Also, the card reader 120 may further include a display capable of outputting a communication state or other information associated with the communication with the IC card 110.

The card reader 120 may receive PIN information of a user. In some embodiments, the card reader 120 may include an interface capable of receiving PIN information of the user. For example, the interface may include a plurality of buttons, but the present disclosure is not limited thereto. For example, the interface may be integrally implemented with a display, like a touch pad.

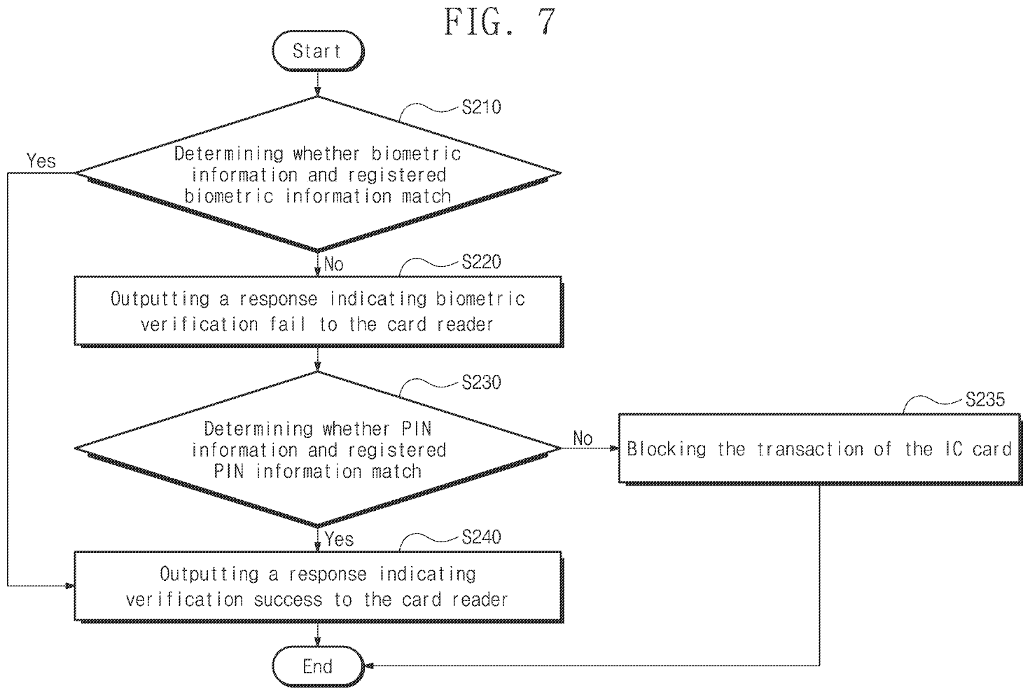

FIG. 7 is a flowchart illustrating an operation method of an IC card according to some embodiments of the present disclosure. The IC card 110 may correspond to the IC card 110 described in FIGS. 1, 2, 3A, 3B, 3C, 4, 5, and 6. An operation method of the IC card 110 will be described with reference to FIGS. 2 and 7.

In operation S210, the IC card 110 may determine whether the biometric information BI and the registered biometric information RBI match. When it is determined in operation S210 that the biometric information BI and the registered biometric information RBI do not match, the IC card 110 may perform operation S220. When it is determined in operation S210 that the biometric information BI and the registered biometric information RBI match, the IC card 110 may perform operation S240.

In some embodiments, when it is determined that the biometric information BI and the registered biometric information RBI do not match, the IC card 110 may further request another biometric information. The IC card 110 may further determine whether the another biometric information and the registered biometric information RBI match.

For example, operation S210 may include receiving first biometric information from a user, determining whether the first biometric information and registered biometric information match, outputting a first response to the card reader 120 in response to determining that the first biometric information and the registered biometric information do not match, receiving second biometric information from the user, and determining whether the second biometric information and the registered biometric information match. The first biometric information may be the biometric information BI. The second biometric information may be another biometric information received after processing the biometric information BI.

In some embodiments, when the trial number of the biometric verification exceeds the reference trial number, the IC card 110 may determine that the biometric information BI and the registered biometric information RBI do not match. The trial number of the biometric verification may refer to the number of times a check of whether biometric information BI and the registered biometric information RBI match occurs. The reference trial number may be a number that is a criterion for determining whether to continue to perform a biometric verification operation, i.e., a threshold number. The reference trial number may be determined in advance by the authenticated user.

For example, operation S210 may include determining the trial number of verification attempts indicating the number of comparing operations of the biometric information BI and the registered biometric information RBI, determining whether the trial number of verification exceeds the reference trial number, and determining that the biometric information BI and the registered biometric information RBI do not match, in response to determining that the trial number of verification exceeds the reference trial number.

In some embodiments, when the trial number of the biometric verification is smaller than or equal to the reference trial number, the IC card 110 may further determine that another biometric information and the registered biometric information RBI match.

For example, operation S210 may include determining the trial number of verification attempts indicating the trial number that the biometric information BI and the registered biometric information RBI are compared, determining whether the trial number of verification exceeds the reference trial number, and determining whether another biometric information received from a user and the registered biometric information RBI match, in response to determining that the trial number of verification is smaller than or equal to the reference trial number.

In operation S220, the IC card 110 may output a response indicating a biometric verification fail to the card reader 120. In some embodiments, when the IC card 110 outputs the response indicating the biometric verification fail to the card reader 120, the IC card 110 may not perform an operation corresponding to a biometric verification request even though any other biometric information is received from the user.

In operation S230, the IC card 110 may determine whether the PIN information PI and the registered PIN information RPI match. When it is determined in operation S230 that the PIN information PI and the registered PIN information RPI do not match, the IC card 110 may perform operation S235. When it is determined in operation S230 that the PIN information PI and the registered PIN information RPI match, the IC card 110 may perform operation S240.

In operation S235, the IC card 110 may block a transaction function of the IC card 110. When it is determined that the PIN information PI and the registered PIN information RPI do not match, the IC card 110 may determine that a user of the IC card 110 is not the authenticated user. That is, it is impossible to make a payment through the IC card 110.

In operation S240, the IC card 110 may output a response indicating a verification success to the card reader 120. For example, based on determining that the user of the IC card 110 is the authenticated user, the IC card 110 may output a response indicating a verification success to the card reader 120. In some embodiments, the verification success may include a biometric verification success and a PIN verification success.

In some embodiments, when the IC card 110 determines that the biometric information BI and the registered biometric information RBI match, the IC card 110 may output a response indicating a biometric verification success to the card reader 120. When the IC card 110 outputs the response indicating the biometric verification success to the card reader 120, a payment of the IC card 110 may be made.

For example, operation S240 may further include outputting a response indicating a biometric verification success to the card reader 120, receiving a transaction request from the card reader 120, and outputting a transaction approval response to the card reader 120 in response to the transaction request.

In some embodiments, when the IC card 110 determines that the PIN information PI and the registered PIN information RPI match, the IC card 110 may output a response indicating a PIN verification success to the card reader 120. When the IC card 110 outputs the response indicating the PIN verification success to the card reader 120, a payment of the IC card 110 may be made.

For example, operation S240 may further include outputting a response indicating a PIN verification success to the card reader 120, receiving a transaction request from the card reader 120, and outputting a transaction approval response to the card reader 120 in response to the transaction request.

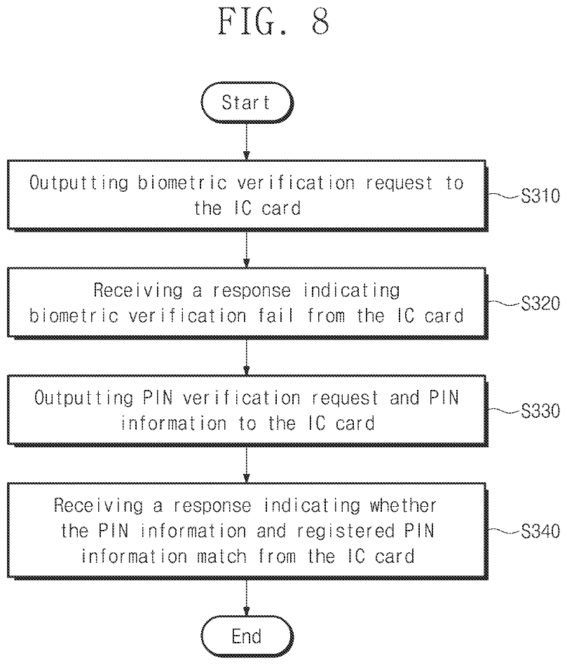

FIG. 8 is a flowchart illustrating an operation method of a card reader according to some embodiments of the present disclosure. The card reader 120 may correspond to the card reader 120 described in FIGS. 1, 5, and 6. An operation method of the card reader 120 will be described with reference to FIGS. 1 and 8.

In operation S310, the card reader 120 may output a biometric verification request to the IC card 110. In some embodiments, the biometric verification request may be a request for determining whether biometric information and biometric information registered through the IC card 110 match. Based on whether the biometric information and the registered biometric information match, whether a user of the IC card 110 is the authenticated user may be verified.

In operation S320, the card reader 120 may receive a response indicating a biometric verification fail from the IC card 110. In some embodiments, the response indicating the biometric verification fail may be a response indicating that the user of the IC card 110 and the authenticated user do not match.

In operation S330, the card reader 120 may output a PIN verification request and PIN information to the IC card 110. In some embodiments, the PIN verification request may be a request for determining whether PIN information and PIN information registered through the IC card 110 match. Based on whether the PIN information and the registered PIN information match, whether the user of the IC card 110 is the authenticated user may be verified. In some embodiments, the PIN information may include information about a series of numbers (or digits) that a current user inputs to the card reader 120.

In operation S340, the card reader 120 may receive a response indicating whether the PIN information and the registered PIN information match, from the IC card 110. In some embodiments, the response indicating whether the PIN information and the registered PIN information match may include a response indicating a PIN verification success or a response indicating a PIN verification fail. The response indicating the PIN verification success may indicate that the user of the IC card 110 and the authenticated user match. The response indicating the PIN verification fail may indicate that the user of the IC card 110 and the authenticated user do not match.

In some embodiments, when the IC card 110 determines that the PIN information and the registered PIN information match, the card reader 120 may communicate with the IC card 110 to process a financial payment.

For example, operation S340 may further include receiving, from the IC card 110, a response indicating a PIN verification success associated with a verification request, outputting a transaction request to the IC card 110 based on the response indicating the PIN verification success, and receiving a transaction approval response from the IC card 110. After the card reader 120 receives the transaction approval response, the card reader 120 may communicate with an external server to process the payment by the authenticated user of the IC card 110.

According to some embodiment of the present disclosure, an operation method of an IC card that is capable of performing an IC card payment through PIN verification even though biometric verification fails is provided.

According to some embodiments of the present disclosure, an IC card including registered biometric information and registered PIN information, an operation method of the IC card, and an operation method of the card reader communicating with the IC card are provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method of operating an integrated circuit (IC) card that is configured to communicate with a card reader, wherein the IC card includes registered biometric information and registered PIN information, the method comprising:
determining whether biometric information received from a user and the registered biometric information on the IC card match;
in response to determining that the biometric information and the registered biometric information do not match, outputting to the card reader, a first response indicating a biometric verification fail;
determining whether PIN information received from the card reader and the registered PIN information on the IC card match, responsive to receiving a PIN verification request from the card reader that was based on the first response indicating the biometric verification fail; and
outputting to the card reader, a second response indicating whether the PIN information and the registered PIN information match.

2. The method of claim 1, wherein the determining whether the PIN information received from the card reader and the registered PIN information on the IC card match comprises:
after outputting the first response to the card reader, determining whether the PIN information received from the card reader and the registered PIN information match.

3. The method of claim 1, wherein the determining whether the biometric information received from the user and the registered biometric information on the IC card match comprises:
receiving first biometric information from the user;
determining whether the first biometric information and the registered biometric information on the IC card match;
in response to determining that the first biometric information and the registered biometric information on the IC card do not match, outputting the first response to the card reader;
receiving second biometric information from the user; and
determining whether the second biometric information and the registered biometric information on the IC card match.

4. The method of claim 1, wherein the determining whether the biometric information received from the user and the registered biometric information on the IC card match comprises:
determining a trial number of verifications indicating a number of times the biometric information and the registered biometric information have been compared;
determining whether the trial number of verifications exceeds a reference trial number; and
in response to determining that the trial number of verifications exceeds the reference trial number, determining that the biometric information and the registered biometric information do not match.

5. The method of claim 1, wherein the determining whether the biometric information received from the user and the registered biometric information on the IC card match comprises:
determining a trial number of verifications indicating a number of comparisons of the biometric information and the registered biometric information that have occurred;
determining whether the trial number of verifications exceeds a reference trial number; and
in response to determining that the trial number of verifications is less than or equal to the reference trial number, determining whether another biometric information received from the user and the registered biometric information on the IC card match.

6. The method of claim 1, further comprising:
in response to determining that the biometric information and the registered biometric information on the IC card match, outputting a third response indicating a biometric verification success to the card reader;
receiving a transaction request from the card reader; and
outputting to the card reader a transaction approval response in response to the transaction request.

7. The method of claim 1, wherein the outputting of the second response indicating whether the PIN information and the registered PIN information on the IC card match to the card reader comprises:
in response to determining that the PIN information and the registered PIN information do not match, blocking a transaction function of the IC card.

8. The method of claim 1, wherein the outputting to the card reader the second response indicating whether the PIN information and the registered PIN information match comprises:
in response to determining that the PIN information and the registered PIN information match, outputting the second response indicating a PIN verification success to the card reader.

9. The method of claim 8, further comprising:
after outputting the second response to the card reader, receiving a transaction request from the card reader; and
outputting a transaction approval response to the card reader in response to the transaction request.

10. The method of claim 1, wherein the registered biometric information comprises fingerprint information of an authenticated user of the IC card.

11. The method of claim 1, wherein the registered PIN information comprises information about a series of numbers determined in advance by an authenticated user of the IC card.

12. An integrated circuit (IC) card comprising:
a biometric sensor configured to generate biometric information; and
a control circuit that is configured to store registered biometric information and registered PIN information, wherein the control circuit is further configured to communicate with the biometric sensor and a card reader that are external to the IC card,
wherein the control circuit is configured to perform operations comprising:
receiving a biometric verification request from the card reader;
determining whether the biometric information and the registered biometric information match, based on the biometric verification request;
outputting a first response indicating a biometric verification fail to the card reader, in response to determining that the biometric information and the registered biometric information do not match;
receiving a PIN verification request and PIN information from the card reader, responsive to the first response indicating the biometric verification fail;
determining whether the PIN information and the registered PIN information match, based on the PIN verification request; and
outputting a second response indicating whether the PIN information and the registered PIN information match, to the card reader.

13. The IC card of claim 12, wherein the biometric sensor is further configured to perform operations comprising:
sensing a fingerprint of a user; and
generating the biometric information based on the fingerprint that was sensed.

14. The IC card of claim 12, further comprising:
a display configured to output the first response and the second response to a user.

15. The IC card of claim 12, wherein the control circuit is further configured to perform operations comprising:
outputting a third response indicating a biometric verification success to the card reader, in response to determining that the biometric information and the registered biometric information match;
receiving a transaction request from the card reader; and
outputting a transaction approval response to the card reader in response to the transaction request.

16. The IC card of claim 12, wherein the control circuit is further configured to perform operations comprising:
outputting the second response indicating a PIN verification success to the card reader, in response to determining that the PIN information and the registered PIN information match.

17. The IC card of claim 16, wherein the control circuit is further configured to perform operations comprising:
receiving a transaction request from the card reader after outputting the second response indicating the PIN verification success to the card reader; and
outputting a transaction approval response to the card reader in response to the transaction request.

18. The IC card of claim 12, wherein the registered biometric information indicates fingerprint information of an authenticated user of the IC card, and
wherein the registered PIN information indicates information about a series of numbers determined in advance by the authenticated user of the IC card.

19. A method of operating a card reader that is configured to communicate with an integrated circuit (IC) card that stores registered biometric information and registered PIN information, the method comprising:
outputting a biometric verification request to the IC card;
receiving, from the IC card, a first response indicating a biometric verification fail of the biometric verification request for the registered biometric information;
outputting a PIN verification request and PIN information to the IC card, based on the first response indicating the biometric verification fail; and
receiving, from the IC card, a second response indicating whether the PIN information and the registered PIN information match.

20. The method of claim 19, wherein the receiving of the second response indicating whether the PIN information and the registered PIN information match from the IC card comprises:
receiving, from the IC card, the second response indicating a PIN verification success of the PIN verification request;
outputting a transaction request to the IC card, based on the second response indicating the PIN verification success; and
receiving a transaction approval response from the IC card.
